(19) United States
(12) Patent Application Publication
(10) Pub. No.: US 2020/0392367 A1
(43) Pub. Date: Dec. 17, 2020

(54) NON-SLIP BOARD AND PRODUCTION PROCESS THEREOF

(71) Applicant: JIANGSU LANGYUE NEW MATERIALS TECHNOLOGY CO., LTD., Jiangsu (CN)

(72) Inventors: Guoping LI, Jiangsu (CN); Bin WU, Jiangsu (CN)

(73) Assignee: JIANGSU LANGYUE NEW MATERIALS TECHNOLOGY CO., LTD., Jiangsu (CN)

(21) Appl. No.: 17/004,020

(22) Filed: Aug. 27, 2020

Related U.S. Application Data
(63) Continuation of application No. PCT/CN2019/080839, filed on Apr. 1, 2019.

(30) Foreign Application Priority Data
Mar. 25, 2019 (CN) 201910227486.5

(51) Int. Cl. C09D 133/08; C09D 7/63; C08F 220/18; E04F 15/02; E04F 15/20; E04F 15/18

(52) U.S. Cl. CPC C09D 133/08; C09D 7/63; C08F 220/1804; E04F 15/02172; E04F 15/206; E04F 2201/043; E04F 15/02038; E04F 2201/0107; E04F 2201/0153; E04F 2201/023; E04F 15/181

(57) ABSTRACT

The present application provides a non-slip board, relating to a technical field of non-slip materials, and aims at solving the problem that after long-term use, the flooring and the sound insulating pad have problems such as deformation, corner warping and the like due to expansion and contraction, which also causes displacement on the base surface. The present application further provides a production process of the non-slip board, in which the non-slip coating layer is applied to a sound insulating pad, a soft resilient floor board, a coiled material, a homogeneous coiled material or a hard floor board, and the sound insulating pad, the coiled material or the hard floor board is not prone to displacement after being laid onto the foundation ground.

### CROSS-REFERENCE TO RELATED APPLICATION

This application is a continuation of international PCT application serial no. PCT/CN2019/080839 filed on Apr. 1, 2019, which claims the priority benefit of China application no. 201910227486.5 filed on Mar. 25, 2019. The entirety of each of the above-mentioned patent applications is incorporated herein by reference and made a part of this specification.

### BACKGROUND OF THE INVENTION

### 1. Technical Field

The present application relates to the technical field of non-slip coatings, in particular to a non-slip board and a production process thereof.

### 2. Description of Related Art

At present, wood boards, composite boards and the like are mostly used for home decoration in the market, and at the same time, resilient floorings made from materials such as PVC/rubber have become increasingly accepted by consumers due to their properties of moisture resistance, super wear resistance, zero formaldehyde, no pollution, light weight and easy maintenance.

With continuous improvement of people's living standards, people's requirements on living conditions are also getting higher and higher, which puts forward new requirements for sound insulation performance of flooring, coiled materials, etc. Chinese Patent Application Publication No. CN108915210A discloses a flooring with a sound insulating pad and a production process thereof. The flooring includes a flooring layer, a bonding layer and the sound insulating pad from top to bottom, wherein the sound insulating pad is made from any one of EVA, IXPE, PE foam, EPEF foam, EPE high-density foam and non-woven fabrics. With the sound insulating pad bonded to the back of the flooring, the flooring is enabled to provide a certain sound insulation property after being paved.

In the prior art, Chinese Patent Granted Publication No. CN104088435B discloses a glue-free paved non-slip flooring, including a wear-resistant layer, a printed color film layer, a first bottom PVC material layer, a first grid glass fiber layer, a first middle PVC material layer, a second bottom PVC material layer, a second grid glass fiber layer, a second middle PVC material layer and a non-slip film layer which are sequentially arranged from top to bottom, wherein the non-slip film layer is a non-slip film made from PVC materials and is bonded by hot pressing. The non-slip flooring possesses good toughness and resilience, reduced hardness and good stability after being paved, and provides convenience for paving without use of glue or interlocking arrangement.

The above existing technical solutions have the following defeciencies: for either the flooring with the sound insulating pad on the back or the non-slip flooring with the non-slip film layer, the product is laid on the base surface only by the self-sinking effect of the product and the friction between the sound insulating pad or the PVC non-slip film and the base surface to make the product be adsorbed onto the base surface without slipping. After long-term use, the flooring and the sound insulating pad may have problems such as deformation, corner warping and the like due to expansion and shrinkage, which also causes displacement on the base surface, and therefore have a need to be further improved.

### SUMMARY OF THE INVENTION

At a first aspect, a non-slip board with good non-slip performance is provided.

In one embodiment, the non-slip board with good non-slip performance includes a board layer and a non-slip coating layer on one surface of the board layer. The non-slip coating layer may include, in percentage by mass, 35-40% of a comonomer, 9-10% of styrene, 0.3-0.5% of acrylic acid, 0.7-1.3% of a compound emulsifier prepared by mixing sodium nonylphenol polyoxyethylene ether sulfate and allyl polyoxyethylene ether in a mass ratio of (3-7):(7-3), 0.1-0.2% of sodium bicarbonate, 49-54% of deionized water, 0.15-0.25% of an ammonium persulfate initiator, and 0.25-0.5% of additional auxiliary.

In another embodiment, a non-slip board includes a board layer and a non-slip coating layer on one surface of the board layer, wherein the non-slip coating layer is formed by applying a coating prepared by the following steps:

weighing: weighing, in percentage by mass, 35-40% of a comonomer, 9-10% of styrene, 0.3-0.5% of acrylic acid, 0.7-1.3% of a compound emulsifier prepared by mixing sodium nonylphenol polyoxyethylene ether sulfate and allyl polyoxyethylene ether in a mass ratio of (3-7):(7-3), 0.1-0.2% of sodium bicarbonate, 49-54% of deionized water, 0.15-0.25% of an ammonium persulfate initiator, and 0.25-0.5% of additional auxiliary;

core emulsion preparation: adding ½-⅔ of the total compound emulsifier, all the sodium bicarbonate and half of the deionized water into a stirring device, performing stirring for 10-15 min with a revolving speed of 300-400 r/min, and heating to 45-50° C.; then, adding ⅖-⅔ of the comonomer and ⅖-⅔ of the styrene, carrying out pre-emulsification for 10-15 min, thereafter, heating to 80-90° C., and then adding half of the ammonium persulfate initiator to obtain a core emulsion;

pre-emulsification: adding the other half of the deionized water into the remaining compound emulsifier, carrying out dispersion for 10-15 min at a temperature of 30-40° C. with a revolving speed of 300-400 r/min, and adding the remaining comonomer, the remaining styrene and all the acrylic acid to obtain a pre-emulsion; and

coating preparation: adding the pre-emulsion into the core emulsion by at least three times, each time together with a corresponding portion of ammonium persulfate initiator uniformly divided from the remaining ammonium persulfate initiator, adding the additional auxiliary thereto, performing stirring for 10-15 min, heating to 80-90° C. and maintaining the heating temperature for 30-40 min, cooling to 30-40° C., and adjusting pH of a system to 7 to obtain the coating.

By adopting the above technical solution, the coating is prepared and applied to the back surface of a corresponding product, and the non-slip coating layer is formed on the back surface of the product after drying. Such non-slip coating layer has a high friction coefficient and persistent stickness, so that the product is not prone to displacement after being laid onto the foundation ground. Moreover, due to the high resilience and high strength of the non-slip coating layer, the product is endowed with good mechanical properties and ductility, so that even if the base surface to be paved has pits, the product can be attached closely to the base surface with the ductility of the coating layer.

Further, the comonomer is any one selected from a group consisting of n-butyl acrylate, butyl methacrylate and isooctyl acrylate; and

the additional auxiliary consists of the following components in percentage by mass:

13-30% of a preservative, and

70-87% of a penetrant.

By adopting the above technical solution, the penetrant provides high adhesion, high penetrability, fast drying and high wear resistance as well as high chemical resistance and water resistance. In a rainy season in South China, water in foundation soil under the ground cushion rises under the capillary action, and a part of the water is transformed into vapor to permeate upwards, which makes the board layer easily get mildewed and deformed by water absorption. By virtue of the preservative, mildew can be further reduced.

Further, the board layer is any one selected from a group including a sound insulating pad, a soft resilient floor board, a coiled material, a homogeneous coiled material and a hard floor board.

By adopting the above technical solution, the non-slip coating is applied to the back surface of the sound insulating pad, and after drying, a piece of release paper is laid onto the back surface of the sound insulating pad, thereby obtaining a composite sound insulating pad with good non-slip performance. Due to the high friction coefficient of the non-slip coating layer, when the non-slip coating layer is applied to a soft resilient floor board, a coiled material, a homogeneous coiled material or a hard floor board, the coiled material, the homogeneous coiled material or the hard floor board is also not prone to displacement after being laid onto the foundation ground.

Further, the board layer is a sound insulating pad, and a flooring layer is arranged on one side, away from the non-slip coating layer, of the sound insulating pad.

By adopting the above technical solution, the flooring layer is compounded to the sound insulating pad, so that the floor board is provided with a certain sound insulation property after being paved and also has a non-slip property, thereby reducing displacement on the base surface during paving.

Further, the board layer is a hard floor board, and one side of the hard floor is provided with a first protrusion, while a side, opposite to the first protrusion, of the hard floor board is provided with a first regular groove for the first protrusion of an adjacent hard floor board to fit into.

By adopting the technical solution, during assembly of the hard floor boards, left and right adjacent hard floor boards are connected with each other through the fitting of the first protrusion and the first regular groove, so that the paving stability of the hard floor boards is further improved, and the occurrence of edge warping and arching is reduced.

Further, a side, adjacent to the first protrusion, of the hard floor board is provided with a second protrusion, while a side, opposite to the second protrusion, of the hard floor board is provided with a second regular groove for the second protrusion of an adjacent hard floor board to fit into, and the second regular groove is in communication with the first regular groove.

By adopting the technical solution, during assembly of the hard floor boards, left and right adjacent hard floor boards are connected with each other through the fitting of the first protrusion and the first regular groove, and front and rear adjacent hard floor boards are connected with each other through the fittings of the second protrusion and the second regular groove, so that the paving stability of the hard floor boards is further improved, and the occurrence of edge warping and arching is reduced.

Further, the board layer is a coiled material, and the coiled material includes a middle material layer, a PVC pattern layer, a PVC wear-resistant layer and a UV cured layer which are sequentially arranged from bottom to top.

By adopting the above technical solution, the composite coiled material has the advantages of wear resistance, slip resistance, high resilience and high strength, wide varieties of patterns and resistance to acid and alkali corrosions. Moreover, with the UV cured layer, the wear resistance of the coiled material is further improved, and the service life of the coiled material is prolonged.

Further, a glass fiber layer is arranged between the middle material layer and the PVC pattern layer.

By adopting the above technical solution, with the glass fiber layer, the strength of the coiled material is further improved. Glass fiber has good stability, which is capable of restraining the coiled material in the plane to a certain extent, thereby preventing arching.

Another object of the present application is to provide a production process of the non-slip board, and the non-slip board produced by the process is advantageous by good non-slip performance.

The present application further provides the following technical solution:

a production process of a non-slip board, including the following steps:

spraying: spraying a coating onto one surface of a board layer to obtain a non-slip coating layer with a thickness of 0.1-0.2 mm; and

drying: drying the board layer with the non-slip coating layer naturally or in an oven tunnel at a temperature of 70-100° C. for ≥24 h.

By adopting the above technical solution, the non-slip coating is applied to one side of the board layer and dried to obtain the non-slip coating layer, and then the non-slip board is laid onto the foundation ground. Due to the high friction coefficient of the non-slip coating layer, the friction between the board layer and the foundation ground is increased by virtue of the non-slip coating layer, so that displacement does not occur easily.

Further, the board layer is a sound insulating pad, and after drying, the production process further includes the following steps:

pasting a clamping part made from transparent PVC to an edge of the non-slip coating layer of the sound insulating pad, and then laying a piece of release paper so that the clamping part is between the release paper and the non-slip coating layer.

By adopting the above technical solution, the non-slip coating layer is applied to the back surface of the sound insulating pad, and after drying, a piece of release paper is laid onto the back surface of the sound insulating pad, thereby obtaining a composite sound insulating pad with good non-slip performance. PVC has a certain hardness, and if the sound insulating pad with the non-slip coating layer is directly attached to the release paper, it is difficult to peel the sound insulating pad from the release paper during use. Moreover, a part of the clamping part is attached between the non-slip coating layer and the release paper, providing convenience for use.

In summary, the present application has the beneficial effects that:

1. the coating is applied to the back surface of a corresponding product, and the non-slip coating layer is formed on the back surface of the product after drying; such non-slip coating layer has a high friction coefficient and persistent stickness, so that the product is not prone to displacement after being laid onto the foundation ground; moreover, due to the high resilience and high strength of the non-slip coating layer, the product is endowed with good flexibility, so that even if the base surface to be paved has pits, the product can be absorbed onto the base surface with the flexibility of the coating layer; and

2. the non-slip coating layer is applied to a sound insulating pad, a soft resilient floor board, a coiled material, a homogeneous coiled material or a hard floor board, and the sound insulating pad, the coiled material, the homogeneous coiled material or the hard floor board is not prone to displacement after being laid onto the foundation ground, thereby obtaining good non-slip performance.

### BRIEF DESCRIPTION OF THE DRAWINGS

FIG. 1 is a schematic view showing an overall structure of Embodiment 7 of the present application;

FIG. 2 is a schematic view showing an overall structure of Embodiment 12 of the present application;

FIG. 3 is a schematic view showing a structure of Embodiment 14 of the present application;

FIG. 4 is a schematic view showing a structure of a hard floor board with interlocking arrangement according to Embodiment 15 of the present application;

FIG. 5 is a schematic view showing a structure of a hard floor board with insert lock arrangement according to Embodiment 16 of the present application;

FIG. 6 is a schematic view showing an assembled structure of hard floor boards with insert lock arrangement according to Embodiment 16 of the present application; and

FIG. 7 is a schematic view showing an assembled structure of hard floor boards according to Embodiment 17 of the present application.

In the drawings:
1. hard floor board
2. first protrusion
21. first regular groove
3. coiled material
31. middle material layer
32. glass fiber layer
33. PVC pattern layer
34. PVC wear-resistant layer
35. UV cured layer
4. non-slip coating layer
5. sound insulating pad
51. release paper
52. flooring layer
53. clamping part
6. second protrusion
61. Second regular groove

### DETAILED DESCRIPTION OF THE INVENTION

The present application will now be explained in further detail with reference to the accompanying drawings.

The present application provides a non-slip board, including a board layer and a non-slip coating layer on one surface of the board layer, in which the board layer is any one selected from a group consisting of a sound insulating pad, a soft resilient floor board, a coiled material, a homogeneous coiled material and a hard floor board. The non-slip coating includes a comonomer, styrene, acrylic acid, a compound emulsifier, an initiator, sodium bicarbonate, additional auxiliary and deionized water.

In some embodiments, n-butyl acrylate was used as the comonomer; 25 wt % ammonia water was used for adjusting the pH of the system; sodium bicarbonate was commercially available industrial grade sodium bicarbonate; 4,5-dichloro-2-octyl-isothiazolone (commonly called DCOIT), purchased from Foshan Lanfeng Auxiliaries Co., Ltd. and having a strong killing effect on most of bacteria and capable of inhibiting reproduction of bacteria, was used as the preservative; and sodium dioctyl sulfosuccinate (commonly called Fast T), which was purchased from Jiangsu Haian Petroleum Chemical Factory, was used as the penetrant.

For the purpose of making use of the feature that a charge stabilization effect of an anionic emulsifier and a steric hindrance effect of a nonionic emulsifier may generate a synergistic effect, a composite system consisting of sodium nonylphenol polyoxyethylene ether sulfate (anionic emulsifier) and allyl polyoxyethylene ether (nonionic emulsifier) was selected as the emulsifier in one embodiment of the present application.

The non-slip coating was prepared by core-shell copolymerization, during which core-shell copolymerization was carried out with styrene as a hard monomer, n-butyl acrylate as a soft monomer and acrylic acid as a crosslinking monomer, thereby obtaining a coating with high resilience and high strength. The original central shell adsorbed the crosslinking monomer to the surface or interior of a latex particle through self-emulsification under the action of the initiator, and then polymerization reaction was initiated. Long chains spread uniformly when the aqueous coating is coated on a surface of an object, in which the hard monomer can improve the structural strength, the load bearing capacity and pressure bearing capacity, and the soft monomer can improve the flexibility of the whole system, thus finally the non-slip coating layer achieves better mechanical properties. Meanwhile, the acrylic monomer can improve the adhesion and the wettability of the latex film and increase the stability of the emulsion.

### Examples 1-4

According to the mass ratio, the contents of the components are shown in the following table:

TABLE 1
Contents of Components of Coatings in Examples 1-4

| Component | Example 1 | | Example 2 | | Example 3 | | Example 4 | |
|---|---|---|---|---|---|---|---|---|
| n-butyl acrylate | 376.5 | kg | 350 | kg | 379.7 | kg | 400 | kg |
| styrene | 100 | kg | 90 | kg | 95 | kg | 90 | kg |
| acrylic acid | 5 | kg | 3 | kg | 4 | kg | 3 | kg |
| sodium nonylphenol | 3.9 | kg | 3.5 | kg | 7 | kg | 3.5 | kg |
| polyoxyethylene ether | | | | | | | | |
| sulfate | | | | | | | | |
| allyl polyoxyethylene | 9.1 | kg | 3.5 | kg | 3 | kg | 3.5 | kg |
| ether | | | | | | | | |
| ammonium persulfate | 2.5 | kg | 1.5 | kg | 2 | kg | 1.5 | kg |
| initiator | | | | | | | | |
| sodium bicarbonate | 2 | kg | 1 | kg | 1.5 | kg | 1 | kg |
| 25 wt. % ammonia water | 6 | kg | 4 | kg | 5 | kg | 4 | kg |
| DCOIT | 1 | kg | 0.5 | kg | 0.8 | kg | 0.5 | kg |
| Fast T | 4 | kg | 3 | kg | 2 | kg | 3 | kg |
| deionized water | 490 | kg | 540 | kg | 500 | kg | 490 | kg |

The coatings in Examples 1-4 were prepared by a same preparation method, and taking Example 4 as an example, the preparation method specifically includes the following steps that:

weighing: 400 kg of n-butyl acrylate, 90 kg of styrene, 3 kg of acrylic acid, 7 kg of an emulsifier, 1 kg of sodium bicarbonate, 490 kg of deionized water and 1.5 kg of ammonium persulfate were weighed according to the contents listed in table 1;

core emulsion preparation: 4.5 kg of the compound emulsifier prepared by mixing, 1 kg of sodium bicarbonate and 245 kg of deionized water were added into a stirring device, stirring was performed for 10 min with a revolving speed of 300 r/min, and the temperature was heated to 45° C.; then, 160 kg of n-butyl acrylate and 54 kg of styrene were added, pre-emulsification was carried out for 10 min, thereafter, the temperature was heated to 80° C., and then 0.75 kg of the ammonium persulfate initiator was added to obtain the core emulsion;

pre-emulsification: the remaining 245 kg of deionized water was added into the remaining 2.5 kg of compound emulsifier, dispersion was carried out for 10 min at a temperature of 30° C. with a revolving speed 300 r/min, and the remaining 240 kg of n-butyl acrylate, the remaining 36 kg of styrene and all 3 kg of acrylic acid were added to obtain a pre-emulsion;

coating preparation: the pre-emulsion was added into the core emulsion by at least three times together with 0.25 kg of the initiator added for each time, DCOIT in a total amount of 0.5 kg and Fast T in a total amount of 3 kg were added, thereafter, stirring was performed for 10 min, the temperature was heated to 80° C. and maintained for 30 min, the temperature decreased to 30° C., and ammonia water was dripped until a system pH value of 7 to obtain the coating; and

spraying: the obtained coating was sprayed onto one surface of a corresponding board layer to obtain a non-slip coating layer with a thickness of 0.2 mm.

In polymerization of an emulsion, the selection and amount of the emulsifier are crucial to the stability and particle size of the emulsion. On the premise of maintaining the characteristics of the emulsion, it is important to select appropriate contents for the emulsifier in order to improve the stability of the polymer emulsion and reduce the particle size of the emulsion.

On the basis of Example 2, Control groups A-C differed from Example 2 in that, 2.5 kg of sodium nonylphenol polyoxyethylene ether sulfate and 2.5 kg of allyl polyoxyethylene ether were used in Control group A; 5 kg of sodium nonylphenol polyoxyethylene ether sulfate and 5 kg of allyl polyoxyethylene ether were used in Control group B; and 7 kg of sodium nonylphenol polyoxyethylene ether sulfate and 7 kg of allyl polyoxyethylene ether were used in Control group C.

TABLE 2
Influence of Use Amount of Emulsifier on Properties of the Coating

| | Control group A | Example 2 | Control group B | Control group C |
|---|---|---|---|---|
| Stability of calcium ion | No | Yes | Yes | No |
| Appearance of | Milky white, no | Milky white, | Milky white, | Weak blue light |
| emulsion | blue light | fine, strong | fine, strong | |
| | | blue light | blue light | |

Compared with example 2, the amount of the emulsifier was reduced in Control group A, so that the stability of calcium ions in the emulsion is low, and the emulsion was less glossy. This is because the surfaces of ions in the emulsion are not completely covered by the emulsifier molecules when the emulsifier is insufficient, so that the charge density on the surfaces of ions in the emulsion is reduced. As the amount of the emulsifier increases, for example, in Example 2 and Control group B, more latex is produced, the stability of the polymerization process is increased, and the rate of emulsion polymerization is increased, providing a glossy emulsion.

Compared with example 2 and Control group B, a large amount of the emulsifier was used in Control group C and the water resistance of the coating film was reduced. This is because, on one hand, the emulsifier is difficult to volatilize when the emulsion is dried to form a film, and the emulsifier is hydrophilic, so that the water resistance of the emulsion film is reduced, and a contact angle of water on the emulsion film is reduced; and, on the other hand, the number of the lipophilic end groups of the emulsifier attached to the macromolecular chain is increased, and the obstruction to chain segment coalescence is increased, so that film forming capability is reduced, and the water resistance is reduced.

The content of the emulsifier is controlled in a range of 0.7-1.3% to improve the wear resistance, pressure resistance, compactness and impermeability of the non-slip coating layer. Due to the good water resistance of the non-slip coating layer, the board layer is not prone to deformation and warping by absorbing vapor of underground water, so that the product is prevented from deformation and warping.

The type of the initiator also influences the stability of the emulsion.

On the basis of Example 3, Control groups 1-2 differ from Example 3 in that, the initiator in Control group 1 was potassium persulfate with an amount of 2 kg; and the initiator in Control group 2 was a mixture of potassium persulfate and sodium bisulfite in a mass ratio of 1:1 with a total amount of 2 kg.

TABLE 3
Influence of Type of Initiator on Properties of Coating

| | Conversion | | | |
|---|---|---|---|---|
| | rate of | | | |
| Initiator | monomer % | Aggregate | Appearance | Gloss |
| Control group 1 | 95.8 | More | White | 85 |
| Example 3 | 97.8 | None | Blue light, | 107 |
| | | | milky white | |
| Control group 2 | 98.2 | None | Blue light, | 120 |
| | | | milky white | |

As can be seen from Table 3, either using potassium persulfate-sodium bisulfite as the initiator or using ammonium persulfate as the initiator was better than using potassium persulfate alone. Aggregates were generated in the process of polymerization when potassium persulfate was used as the initiator, whereas, when potassium persulfate-sodium bisulfite or ammonium persulfate was used as the initiator, the polymerization process was stable with substantially no aggregate generated, and the composite latex particles had a small particle size and a narrow distribution in particle size.

### ExampleS 5-6

On the basis of Example 3, Examples 5-6 differ from Example 3 in that, 5 kg of acrylic acid was used in Example 5, 3 kg of acrylic acid was used in Example 6, and 0 kg of acrylic acid was used in a blank control group.

TABLE 4
Influence of Amount of Acrylic Acid on
Properties of Coating and Coating Film

| Amount of Acrylic | Stickness/ | Adhesion/ | Flexibility/ | Water |
|---|---|---|---|---|
| acid/g | (mPa · s) | level | mm | absorption/% |
| Blank control group | 70.0 | 3 | 1 | 1.8 |
| Example 3 | 140.2 | 1 | 2 | 5.7 |
| Example 5 | 150.8 | 1 | 2 | 10.8 |
| Example 6 | 120.5 | 1 | 2 | 2.1 |

As can be seen from the above table, with the increase in the amount of acrylic acid, both the stickness and water absorption of the coating were increased. The reason might be that acrylic acid is a hydrophilic monomer, and the water absorption is increased by using it in a large amount.

### Example 7

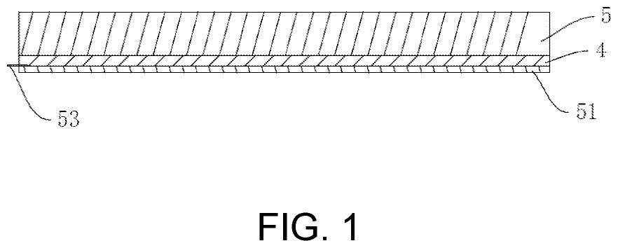

Referring to FIG. 1, a sound insulating pad with a non-slip coating layer containing the coating prepared in Example 4 was prepared as follows:

spraying: the coating prepared in Example 4 was sprayed onto a bottom surface of a sound insulating pad 5 to obtain a non-slip coating layer 4 with a thickness of 0.2 mm;

drying: the sound insulating pad 5 with the non-slip coating layer 4 was dried in an oven tunnel at a temperature of 70° C. for 24 h; and

after drying, a clamping part 53 made from transparent PVC was bonded to an edge of the non-slip coating layer 4 of the sound insulating pad 5, and then a piece of release paper 51 was laid so that the clamping part 53 was between the release paper 51 and the non-slip coating layer 4. The clamping part 53 facilitated removal of the release paper 51 in later use. The release paper 51 was formed by coating silicone oil, and after the silicone oil is dried into shape, the surface of the release paper 51 was smooth and non-stick to glue.

In this Example, the sound insulating pad 5 was an EVA foam sound insulating pad.

### Example 8

This example provided a sound insulating pad with a non-slip coating layer which was based on example 7 and differed from example 7 in that: the sound insulating pad 5 was an IXPE foam sound insulating pad. The IXPE foam sound insulating pad had a smooth surface and uniform and dense foam cells, so that uneven distribution of moisture caused by nonuniform foam cells was prevented when moisture diffused, thereby preventing the sound insulating pad 5 from arching to a certain extent.

### Example 9

This example provided a sound insulating pad with a non-slip coating layer which was based on example 7 and differed from example 7 in that: the sound insulating pad 5 was a PVC sound insulating pad.

### Example 10

This example provided a sound insulating pad with a non-slip coating layer which was based on example 7 and differed from example 7 in that: the sound insulating pad 5 was a non-woven fabric sound insulating pad.

### Example 11

This example provided a sound insulating pad with a non-slip coating layer which was based on example 7 and differed from example 7 in that: the sound insulating pad 5 was a fiber felt sound insulating pad.

Friction coefficients of sound insulating pads with the non-slip coating layers of Examples 7-11 were measured in accordance with the provisions of ISO 8295-1995, while the friction coefficients of sound insulating pads without non-slip coating layers compared with Examples 7-11 were measured as comparison.

TABLE 5
Friction Coefficients of sound insulating pads
with and without Non-slip Coating Layers

| | Static | Kinetic |
|---|---|---|
| | friction | friction |
| | coefficient | coefficient |
| Example 7 | 0.734 | 0.537 |
| EVA foam sound insulating pad without non-slip | 0.417 | 0.324 |
| coating layer compared with Example 7 | | |
| Example 8 | 0.965 | 0.648 |
| IXPE foam sound insulating pad without non-slip | 0.521 | 0.316 |
| coating layer compared with Example 8 | | |
| Example 9 | 0.756 | 0.623 |
| PVC sound insulating pad without non-slip | 0.502 | 0.439 |
| coating layer compared with Example 9 | | |
| Example 10 | 0.787 | 0.523 |
| Non-woven fabric sound insulating pad without | 0.398 | 0.295 |
| non-slip coating layer compared with Example 10 | | |
| Example 11 | 0.765 | 0.586 |
| Fiber felt sound insulating pad without non-slip | 0.512 | 0.423 |
| coating layer compared with Example 11 | | |

As can be seen from the above table, the sound insulating pads with the non-slip coating layers had larger static and kinetic friction coefficients and better non-slip performance compared with the sound insulating pads without the non-slip coating layers. When the product was laid onto the foundation ground, the release paper was peeled off, and the non-slip coating layer was attached to the surface of the foundation ground, so that the product was not prone to displacement, thereby improving the stability of paving.

The tensile strength and elongation at break of the sound insulating pads with the non-slip coating layers in Examples 7-11 were measured according to GB/T528. The non-slip boards were made into dumbbell-shaped samples, the samples of the non-slip boards in Examples 7-11 were uniformly arranged on upper and lower holders of a tensile tester, and the moving speed of the holders was adjusted to (500±50) mm/min.

The compression set of sound insulating pads with the non-slip coating layers of Examples 7-11 were measured according to GB/T7759. The non-slip boards were made into samples having a diameter of (29±0.5) mm and a height of (12.5±0.5) mm, and a compression rate of 25% was selected to carry out compression set tests.

TABLE 6
Performance Test Results of Examples 7-11

| | | Tensile | | |
|---|---|---|---|---|
| | Compression | strength/ | Elongation | Appearance |
| | set/% | MPa | at break/% | of Products |
| Example | 42 | 1.5 | 150 | Smooth surface, no |
| 7 | | | | warping, no cracking |
| Example | 43 | 1.4 | 151 | Smooth surface, no |
| 8 | | | | warping, no cracking |
| Example | 49 | 1.2 | 149 | Smooth surface, no |
| 9 | | | | warping, no cracking |
| Example | 50 | 1.3 | 148 | Smooth surface, no |
| 10 | | | | warping, no cracking |
| Example | 48 | 1.2 | 149 | Smooth surface, no |
| 11 | | | | warping, no cracking |

As can be seen from the above table, the sound insulating pads with the non-slip coating layers had excellent resilience and strength and a smooth surface without warping or cracking.

### Example 12

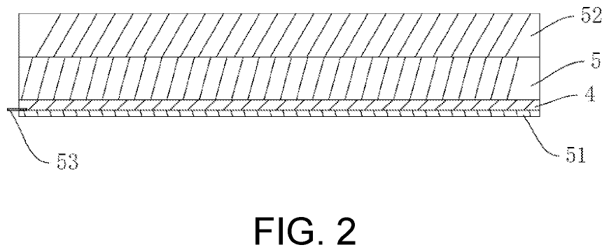

Referring to FIG. 2, a sound insulating pad with a flooring bonded to the top and a non-slip coating layer applied to the bottom, which adopted the coating prepared in Examples 4, was prepared as follows:

Step 1: a bonding layer was applied to a top surface of a sound insulating pad 5, in which an acrylic adhesive being Ailete 221AB adhesive-Ailete 221 epoxy adhesive purchased from Ailete Corporation was adopted as the bonding layer;

Step 2: the sound insulating pad 5 with the adhesive layer prepared in Step 1 was bonded to a flooring layer 52;

Step 3: the coating prepared in example 4 was applied to a bottom surface of the sound insulating pad 5 by roll coating to obtain the non-slip coating layer 4 with a thickness of 0.2 mm;

Step 4: the sound insulating pad 5 with the non-slip coating layer 4 was dried in an oven tunnel at a temperature of 85° C. for 24 h; and

Step 5: after drying, a piece of release paper 51 was laid onto the non-slip coating layer 4 of the sound insulating pad 5.

In this example, the composite flooring layer 52 was any one selected from a group consisting of a soft resilient floor board, a hard floor board, a solid wood floor board and a mineral floor board, and the floor board provided a non-slip property as well as a good sound insulating effect after being bonded. The flooring layer 52, the sound insulating pad 5 and the ground were tightly connected into a whole under the action of the adhesive, so that the flooring layer 52 was effectively prevented from deformation and arching.

### Example 13

A soft resilient floor board with a non-slip coating layer, which adopted the coating prepared in example 4, was prepared as follows:

spraying: the coating prepared in Example 4 was sprayed onto a bottom surface of a soft resilient floor board to obtain a non-slip coating layer with a thickness of 0.1 mm; and

drying: the soft resilient floor board with the non-slip coating layer was dried in an oven tunnel at a temperature of 85° C. for 24 h.

### Example 14

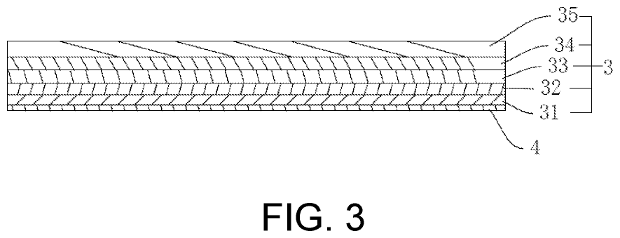

Referring to FIG. 3, a coiled material with a non-slip coating layer, which includes a middle material layer 31, a glass fiber layer 32, a PVC pattern layer 33, a PVC wear-resistant layer 34, and a UV cured layer 35 arranged sequentially from bottom to top and adopts the coating prepared in Example 4, was prepared as follows:

Step 1: a chopped glass fiber was added into the middle material layer 31 to form the glass fiber layer 32, and the PVC wear-resistant layer 34, the PVC pattern layer 33, the glass fiber layer 32 and the middle material layer 31 were subjected to hot-pressing bonding treatment at a treatment temperature of 120° C. for 50 min under a pressure of 12 mpa;

chopped glass fiber had good stability, which was capable of restraining the coiled material in the plane to a certain extent, thereby preventing arching; and natural stone-powder was added into the glass fiber layer 32, so that the strength was increased;

Step 2: UV treatment was carried out, in which an epoxy acrylic UV coating was applied to a top surface of the PVC wear-resistant layer 34, and a UV cured layer 35 was formed after UV curing;

the epoxy acrylic UV coating was purchased from Hengxing Co., Ltd. and Akzo Nobel N.V.;

Step 3: the coating prepared in example 4 was sprayed onto a bottom surface of the coiled material 3 to obtain the non-slip coating layer 4 with a thickness of 0.1 mm; and

Step 4: the coiled material 3 with the non-slip coating layer 4 was dried in an oven tunnel at a temperature of 85° C. for 24 h.

In this example, the coiled material 3 was a PVC coiled material, and the middle material layer 31 was a PVC middle material layer.

Further, the coiled material was not limited to the PVC coiled material, while a homogeneous rubber coiled material, a homogeneous EVA coiled material and the like can also be used.

Part of performance parameters of the PVC coiled material with the non-slip coating layer in example 14 were measured.

Shrinkage: measured with a precision high-temperature oven tester HQ-WG-550; and

Hardness: measured with a Shore hardness tester SLX-D.

TABLE 7
Performance Comparison of Coiled material
added with and without Glass Fiber Layer

| | Shrinkage | Hardness |
|---|---|---|
| Without glass fiber layer | 0.1% | 65HD |
| Example 14 | 0.06% | 70HA |

As can be seen from Table 7, the use of the glass fiber layer led to great reduction in shrinkage, reduction in hardness and obviously improvement in flexibility of the coiled material, so that the phenomenon of warping of the product was reduced, improving the performance of the product.

### Example 15

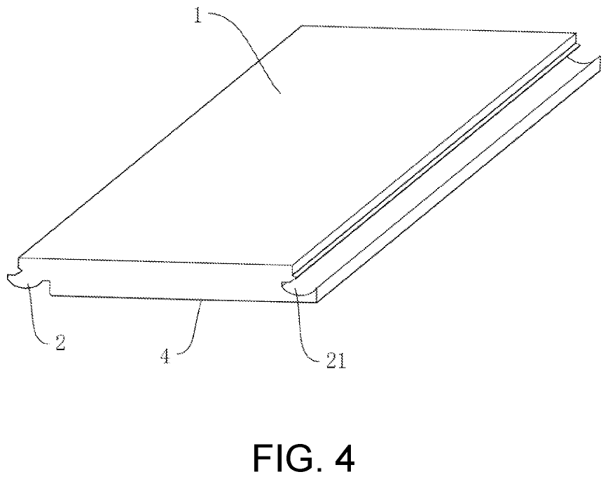

Referring to FIG. 4, a hard floor board with a non-slip coating layer was provided, in which the hard floor board had a standard of thickness being 2-12 mm. In a table resilience test, a natural sagging height was ΔL<500 mm.

The table resilience test included the following steps:

Step 1: a table was adjusted to be horizontal with a height of H0 (H0≥600 mm), a line was drawn at 400 mm from an edge of the table where one end of a test piece of the hard floor board was placed;

Step 2: a steel plate (450*450 mm) was used to press one end of the test piece on the table, while the other end of the test piece sags naturally, in which one side of the steel board was aligned with the edge of the table, and a 5 Kg weight was put on the steel board; and

Step 3: after the test piece was stabilized, the height from the ground to a lowest sagged end of the test piece was measured with a tape measure and recorded as H1. A sag distance of the test piece was ΔL=H0-H1. If the natural sagging height ΔL<500 mm, the test piece was a hard floor board.

The hard floor board 1 with the non-slip coating layer, which adopted the coating prepared in Example 4, was prepared as follows:

spraying: the coating prepared in Example 4 was sprayed onto a bottom surface of a hard floor board 1 to obtain a non-slip coating layer 4, in which the non-slip coating layer 4 had a thickness of 0.1 mm, and in this example, the hard floor board 1 had a thickness of 2 mm; and

drying: the hard floor board 1 with the non-slip coating layer 4 was dried in an oven tunnel at a temperature of 85° C. for 24 h.

In this example, the hard floor board 1 was a hard PVC floor board, and a first protrusion 2 was integrally formed on one side of the hard floor board 1, while a first regular groove 21 was formed in another side of the hard floor board 1. The first protrusion 2 was hook-shaped, and in assembly of the hard floor boards 1, left and right adjacent hard floor boards 1 were connected with each other through the fit connection of the first protrusion 2 with the first regular groove 21, so that the paving stability was improved, the occurrence of edge warping and arching of the hard floor boards 1 was reduced, and the floor board was not prone to displacement.

### Example 16

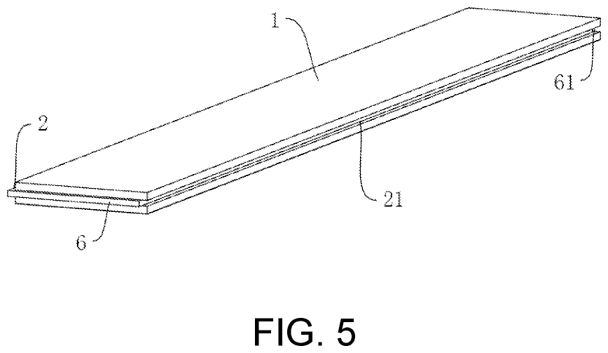

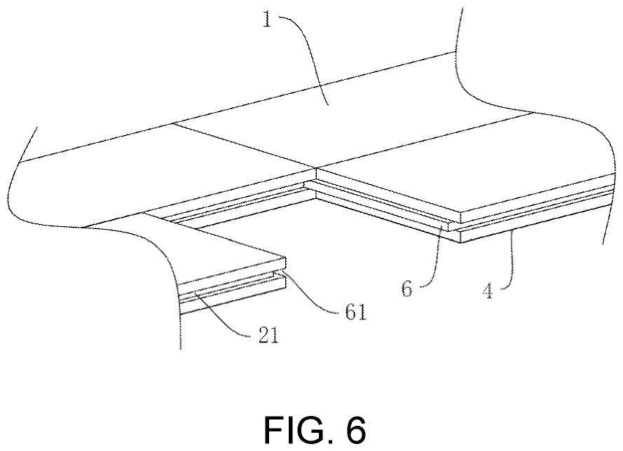

Referring to FIGS. 5 and 6, a hard floor board with a non-slip coating layer, which adopted the coating prepared in Example 4, was prepared as follows:

spraying: the coating prepared in Example 4 was sprayed onto the bottom of a hard floor board 1 to obtain a non-slip coating layer 4, in which the non-slip coating layer 4 had a thickness of 0.1 mm, and the hard floor board 1 had a thickness of 2.5 mm; and

drying: the hard floor board with the non-slip coating layer 4 was dried in an oven tunnel at a temperature of 85° C. for 24 h.

In this example, the hard floor board 1 was a hard solid wood floor board, and a first protrusion 2 was connected to one side of the hard floor board 1, while a first regular groove 21 was formed in another side of the hard floor board 1. During assembling the hard floor boards 1, adjacent left and right hard floor boards 1 were connected with each other through the fit connection of the first protrusion 2 with the first regular groove 21. A second protrusion 6 was integrally formed on one side of the hard floor board 1 adjacent to the side where the first protrusion 2 was located. A second regular groove 61 was formed in the back of the hard floor board 1 and was in communication with the first regular groove 21. Adjacent front and rear hard floor boards 1 were connected with each other through the fit connection of the second protrusion 2 with the second regular groove 61, so that the paving stability of the hard floor boards 1 was improved, the occurrence of edge warping and arching was reduced, and the floor board was not prone to displacement.

### Example 17

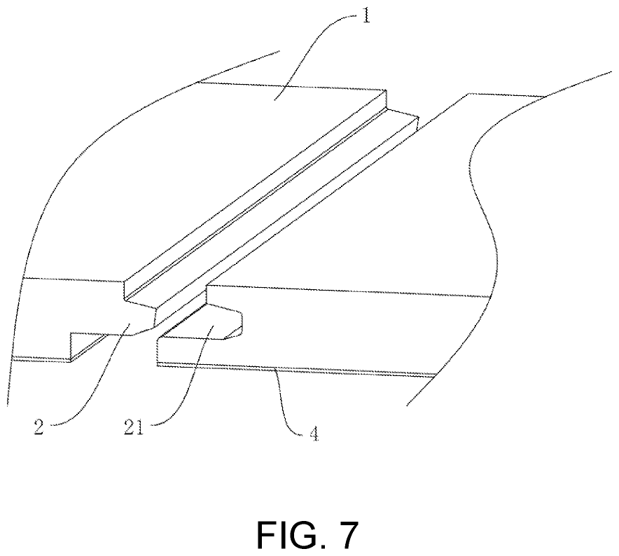

Referring to FIG. 7, a hard floor board with a non-slip coating layer, which adopted the coating prepared in example 4, was prepared as follows:

spraying: the coating prepared in example 4 was sprayed onto the bottom of a hard floor board 1 to obtain a non-slip coating layer 4, in which the non-slip coating layer 4 had a thickness of 0.1 mm, and the hard floor board 1 had a thickness of 2 mm; and

drying: the soft hard floor board with the non-slip coating layer was dried in an oven tunnel at a temperature of 85° C. for 24 h.

In this example, the hard floor board 1 was a hard PVC floor board, and a first protrusion 2 was connected to one side of the hard floor board 1, while a first regular groove 21 was formed in another side of the hard floor board 1. The section of the first regular groove 21 was V-shaped. Through the fit connection of the first strip 2 with the regular groove 21, two adjacent hard floor boards 1 can be spliced together without the need for lock arrangement, this was because it has been ensured that the floor board cannot slip due to the non-slip coating layer 4. The difference between heights of adjacent hard floor boards 1 can be controlled by the first protrusion 2, so that the hard floor boards 1 were flat and not prone to warping after being paved.

The hard floor boards with the non-slip coating layers in examples 20-22 were tested for static bending strength, thickness swelling rate of water absorption and warpage according to the provisions of GB/T11718-2009, GB/T18102-2007 and EN 434, and the records were shown in Table 8.

TABLE 8
Performance Results of Floor Boards with
Non-slip Coating Layers of examples 15-17

| | | Thickness | |
|---|---|---|---|
| | | swelling rate | |
| | Static bending | of water | |
| | strength/MPa | absorption/% | Warpage/mm |
| Example 15 | 27.2 | 0.12 | 0.6 |
| Example 16 | 28.3 | 0.13 | 0.5 |
| Example 17 | 27.0 | 0.12 | 0.5 |
| Standard | GB/T11718- | GB/T18102- | EN434 ≤2.0 |
| | 2009, 27.0 | 2007, ≤18 | |
| | (≥1.5-3 mm) | | |

As can be seen from Table 8, the above hard floor board had good resilience and strength, and good mechanical properties. Due to the high resilience and high strength of the product obtained by virtue of the non-slip coating layer, the product was endowed with good flexibility, so that even if the base surface to be paved had pits, the product can be attached to the base surface with the flexibility of the coating layer. In addition, as the coating had high adhesion and high water resistance, the hard floor board was improved in wear resistance, pressure resistance, compactness and impermeability, and was not prone to deformation and warping by absorption of water, so that the displacement was reduced.

The embodiments of the present application are all preferred embodiments of the application, and are not intended to limit the scope of the application. Accordingly, any equivalent variations made based on the shape, structure and principles of present application are intended to be included within the scope of the present application.

What is claimed is:

1. A non-slip board, comprising a board layer and a non-slip coating layer on one surface of the board layer, wherein the non-slip coating layer is formed by applying a coating prepared by the following steps:
weighing: weighing, in percentage by mass, 35-40% of a comonomer, 9-10% of styrene, 0.3-0.5% of acrylic acid, 0.7-1.3% of a compound emulsifier prepared by mixing sodium nonylphenol polyoxyethylene ether sulfate and allyl polyoxyethylene ether in a mass ratio of (3-7):(7-3), 0.1-0.2% of sodium bicarbonate, 49-54% of deionized water, 0.15-0.25% of an ammonium persulfate initiator, and 0.25-0.5% of additional auxiliary;
core emulsion preparation: adding ½-⅔ of total of the compound emulsifier, all the sodium bicarbonate and half of the deionized water into a stirring device, performing stirring for 10-15 min with a revolving speed of 300-400 r/min, and heating to 45-50° C.; then, adding ⅖-⅔ of the comonomer and ⅖-⅔ of the styrene, carrying out pre-emulsification for 10-15 min, thereafter, heating to 80-90° C., and then adding half of the ammonium persulfate initiator to obtain a core emulsion;
pre-emulsification: adding the other half of the deionized water into the remaining compound emulsifier, carrying out dispersion for 10-15 min at a temperature of 30-40° C. with a revolving speed of 300-400 r/min, and adding the remaining comonomer, the remaining styrene and all the acrylic acid to obtain a pre-emulsion; and
coating preparation: adding the pre-emulsion into the core emulsion by at least three times together with the remaining ammonium persulfate initiator uniformly divided into corresponding parts for each time, adding the additional auxiliary, thereafter, performing stirring for 10-15 min, heating to 80-90° C. and maintaining the heating temperature for 30-40 min; cooling to 30-40° C., and adjusting pH of a system to 7 to obtain the coating.

2. The non-slip board according to claim 1, wherein the comonomer is any one selected from a group consisting of n-butyl acrylate, butyl methacrylate and isooctyl acrylate; and
the additional auxiliary consists of the following components in percentage by mass:
13-30% of an preservative, and
70-87% of a penetrant.

3. The non-slip board according to claim 1, wherein the board layer is any one selected from a group comprising a sound insulating pad, a soft resilient floor board, a coiled material, a homogeneous coiled material, and a hard floor board.

4. The non-slip board according to claim 3, wherein the board layer is a sound insulating pad, and a flooring layer is arranged on one side, away from the non-slip coating layer, of the sound insulating pad.

5. The non-slip board according to claim 3, wherein the board layer is a hard floor board, and one side of the hard floor board is provided with a first protrusion, while a side, opposite to the first protrusion, of the hard floor board is provided with a first regular groove for the first protrusion of an adjacent hard floor board to fit into.

6. The non-slip board according to claim 5, wherein a side, adjacent to the first protrusion, of the hard floor board is provided with a second protrusion, while a side, opposite to the second protrusion, of the hard floor board is provided with a second regular groove for the second protrusion of an adjacent hard floor board to fit into, and the second regular groove is in communication with the first regular groove.

7. The non-slip board according to claim 3, wherein the board layer is a coiled material, and the coiled material comprises a middle material layer, a PVC pattern layer, a PVC wear-resistant layer and a UV cured layer which are sequentially arranged from bottom to top.

8. The non-slip board according to claim 7, wherein a glass fiber layer is arranged between the middle material layer and the PVC pattern layer.

9. A production process of the non-slip board according to claim 1, comprising the following steps:
spraying: spraying a coating onto one surface of a board layer to obtain a non-slip coating layer with a thickness of 0.1-0.2 mm; and
drying: drying the board layer with the non-slip coating layer naturally or in an oven tunnel at a temperature of 70-100° C. for ≥24 h.

10. The production process of the non-slip board according to claim 9, wherein the board layer is a sound insulating pad, and after drying, the production process further comprises the following steps:
pasting a clamping part made of transparent PVC to an edge of the non-slip coating layer of the sound insulating pad, and then laying a release paper so that the clamping part is between the release paper and the non-slip coating layer.
